(19) United States
(12) Patent Application Publication
(10) Pub. No.: US 2016/0229123 A1
(43) Pub. Date: Aug. 11, 2016

(54) REMOTE THREE-DIMENSIONAL CONTINUOUS LIQUID INTERFACE PRODUCTION (CLIP) SYSTEMS, RELATED PRINTERS, AND METHODS OF OPERATING THE SAME

(71) Applicant: Carbon3D, Inc., Redwood City, CA (US)

(72) Inventors: Craig B. Carlson, Los Altos, CA (US); Abhishek Parmar, Palo Alto, CA (US)

(21) Appl. No.: 14/878,409

(22) Filed: Oct. 8, 2015

Related U.S. Application Data
(60) Provisional application No. 62/113,725, filed on Feb. 9, 2015.
(60) Provisional application No. 62/232,526, filed on Sep. 25, 2015.

(51) Int. Cl. B29C 67/00

(52) U.S. Cl. CPC B29C 67/0088; B29C 67/0055; B29K 2105/0058

(57) ABSTRACT

Remote three-dimensional (3D) Continuous Liquid Interface Production (CLIP) systems are provided. The systems may include a plurality of 3D CLIP printers configured to fabricate 3D objects responsive to remote data corresponding the 3D objects. The plurality of 3D CLIP printers may be operatively coupled to a network by which the remote data is received by the plurality of 3D CLIP printers.

### RELATED APPLICATIONS

This application claims priority of U.S. Provisional Patent Application Ser. No. 62/113,725, filed Feb. 9, 2015, and U.S. Provisional Patent Application Ser. No. 62/232,526, filed Sep. 25, 2015, the disclosures of all of which are hereby incorporated by reference herein in their entireties.

### FIELD

The present invention relates, generally, to the fabrication of three-dimensional objects and, more particularly, to additive printing of three-dimensional objects.

### BACKGROUND

In some conventional additive fabrication techniques, construction of a three-dimensional object may be performed in a step-wise or layer-by-layer manner. For example, layers may be formed through solidification of a photo curable resin responsive to visible or UV light irradiation. One such known technique can provide new layers formed at the top surface of an object being fabricated. Another technique can provide new layers at the bottom surface of the object being fabricated.

Some examples of these approaches are discussed in U.S. Pat. Nos. 5,236,637, 7,438,846, 7,892,474, US Patent Publication No. 2013/0292862, and US Patent Publication No. 2013/0295212.

Another approach includes that used by the B9Creator™ 3-dimensional printer marketed by B9Creations of Deadwood, S. Dak., USA.

A cloud printing system may provide users with an ability to print documents from an application or device, using a cloud-aware printer. In other words, the cloud printing system may provide an ability for an application running on a device within a network to communicate with a cloud print service, to thereby print to the cloud-aware printer in communication with the cloud print service. In one example, an application may send a print request, over a network, to the cloud print server for printing a document using the cloud print service. Upon selection of the cloud-aware printer, the cloud print service may receive, over the network, the print job including the document subject to the print request.

### BRIEF DESCRIPTION OF THE DRAWINGS

FIG. 1 is a block diagram illustrating a system providing remote three-dimensional (3D) printing, such as 3D continuous liquid interface production (CLIP), in a network environment in some embodiments according to the invention.

FIG. 2 is a block diagram of a 3D printer, such as a 3D CLIP printer, in some embodiments according to the invention.

FIG. 3 is a block diagram of a computing device suitable for use in the network environment shown in FIG. 1 deployed in support of the remote 3D printers in some embodiments according to the invention.

FIG. 4 is a first flow chart illustrating control systems and methods for the remote 3D printers.

FIG. 5 is a second flow chart illustrating control systems and methods for the remote 3D printers.

FIG. 6 is a third flow chart illustrating control systems and methods for the remote 3D printers.

### SUMMARY OF THE INVENTION

While the present invention is described with specific reference to Continuous Liquid Interface Production (CLIP), it will be appreciated that other types of additive manufacturing, including bottom-up and top-down types of additive manufacturing, as well as fused deposition modeling (FDM) and ink-jet printing implemented 3D printing, may also be used.

A first aspect of the invention is, accordingly, a remote three-dimensional (3D) Continuous Liquid Interface Production (CLIP) system including a plurality of 3D CLIP printers configured to fabricate 3D objects responsive to remote data corresponding the 3D objects. The plurality of 3D CLIP printers may be operatively coupled to a network by which the remote data is received by the plurality of 3D CLIP printers.

In some embodiments, the system further includes a remote 3D CLIP print server operatively coupled to the network. The remote 3D CLIP print server may be configured to provide a remote 3D CLIP print service by which fabrication jobs corresponding to the 3D objects are provided to the plurality of 3D CLIP printers.

In some embodiments, the system further includes an electronic device operatively coupled to the network. The electronic device may be configured to operatively couple to the remote 3D CLIP print service via the network to dispatch a respective fabrication job to a selected one of the plurality of 3D CLIP printers.

In some embodiments, the remote 3D CLIP print service is configured to identify the selected one of the plurality of 3D CLIP printers.

In some embodiments, the remote 3D CLIP print service is configured to identify the selected one of the plurality of 3D CLIP printers responsive to a remote input at the electronic device.

In some embodiments, the system further includes a 3D CLIP modeling server operatively coupled to the network. The 3D CLIP modeling server may be configured to provide a remote 3D CLIP modeling service by which the remote data is processed to provide an input to the plurality of 3D CLIP printers.

In some embodiments, the input provided by the remote 3D CLIP modeling service includes values for fabrication parameters utilized by the plurality of 3D CLIP printers for fabrication of the corresponding the 3D objects.

In some embodiments, the 3D CLIP modeling server is configured to receive a remote input via the network. The remote 3D CLIP modeling service processes the remote data, the remote input and log data of past fabrication jobs performed by the plurality of 3D CLIP printers to provide the input to the plurality of 3D CLIP printers for fabrication. The input provided by the remote 3D CLIP modeling service includes values for fabrication parameters utilized by the plurality of 3D CLIP printers for fabrication of the corresponding the 3D objects or a message identifying a possible failure mode or infeasible fabrication parameters.

In some embodiments, the fabrication parameters include a fabrication orientation, a thickness of a portion of the 3D objects that is fabricated using a set of the fabrication parameters, a fabrication speed, a mode of irradiation and/or a temperature of a polymerizable liquid used to fabricate the 3D objects.

In some embodiments, the remote input data includes a type of a polymerizable liquid, a resolution and/or a fabrication speed.

In some embodiments, the log data of past fabrication jobs includes an accumulated time that a build window in ones of the plurality of 3D CLIP printers has been used, a number of fabrication jobs that have been performed using a build window in ones of the plurality of 3D CLIP printers and/or sub-regions of a build window in ones of the plurality of 3D CLIP printers that have been used.

In some embodiments, the remote 3D CLIP print service is configured to dispatch a respective fabrication job to a selected one of the plurality of 3D CLIP printers based on log data of past fabrication jobs performed by the plurality of 3D CLIP printers.

A second aspect of the invention is, accordingly, a three-dimensional (3D) Continuous Liquid Interface Production (CLIP) printer configured to sequentially fabricate, in situ, contiguous portions of a 3D object in a gradient of polymerization including a network access manager configured to operatively couple to a network to provide the 3D CLIP printer via the network.

In some embodiments, the network access manager is further configured to operatively couple to a remote 3D CLIP print service by which a fabrication job corresponding to the 3D object is provided to the 3D CLIP printer.

In some embodiments, the network access manager is further configured to operatively couple to a 3D CLIP modeling server configured to provide a remote 3D CLIP modeling service by which remote data corresponding the 3D object is processed to provide an input to the 3D CLIP printer.

In some embodiments, the input provided by the remote 3D CLIP modeling service includes values for fabrication parameters utilized by the 3D CLIP printer for fabrication of the corresponding the 3D object.

A third aspect of the invention is, accordingly, a remote three-dimensional (3D) Continuous Liquid Interface Production (CLIP) system including a registration manager operatively coupled to a network. The registration manager is configured to store identification information for each registered remote 3D CLIP printers and identification information for at least one sub-assembly in each registered remote 3D CLIP printers. The registration manager is further configured to track whether the at least one sub-assembly in the each registered remote 3D CLIP printer is authorized by an entity having authority to control operation of the registered remote 3D CLIP printers using the identification information for the each sub-assembly.

In some embodiments, the registration manager is further configured to disable ones of the remote 3D CLIP printers in which an unauthorized sub-assembly is installed.

In some embodiments, the sub-assembly includes a build window, and the identification information for the sub-assembly includes a serial number.

In some embodiments, the registration manager is further configured to notify the entity of usage of an unauthorized sub-assembly in ones of the registered remote 3D CLIP printers.

A third aspect of the invention is, accordingly, a remote three-dimensional (3D) Continuous Liquid Interface Production (CLIP) system including a 3D CLIP printer configured to fabricate a 3D object responsive to remote data corresponding the 3D object. The 3D CLIP printer is operatively coupled to a network by which the remote data is received by the 3D CLIP printer. The 3D CLIP printer includes a build window, a carrier and a printer body, and the printer body includes a positioning circuit configured to position the build window and the carrier at starting heights that are determined based on identification information for the 3D CLIP printer, the build window and the carrier.

In some embodiments, each of the build window and the carrier includes a data store circuit configured to store the identification information for the build window and the carrier, and the printer body of the 3D CLIP printer includes a communication circuit configured to receive the identification information for the build window and the carrier from the data store circuits of the build window and the carrier.

In some embodiments, the communication circuit is configured to receive the identification information for the build window and the carrier by performing near-field communication (NFC) with the data store circuits of the build window and the carrier.

In some embodiments, the printer body of the 3D CLIP printer includes a body data store circuit configured to provide the starting heights of the build window and the carrier to the positioning circuit responsive to the identification information for the build window and the carrier received from the communication circuit and the identification information for the 3D CLIP printer.

In some embodiments, the system may further include a remote 3D CLIP print server operatively coupled to the network and configured to provide the starting heights of the build window and the carrier responsive to the identification information for the 3D CLIP printer, the build window and the carrier.

### DETAILED DESCRIPTION OF EMBODIMENTS ACCORDING TO THE INVENTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art. Like numbers refer to like elements throughout.

As described herein, systems, devices, and methods can provide for the remote fabrication of three-dimensional (3D) objects. While a variety of additive manufacturing methods and apparatus may be used, in some embodiments, the 3D objects can be produced remotely using a liquid interface, which may be referred to as remote “Continuous Liquid Interface Printing” or “Continuous Liquid Interface Production” (CLIP), these terms being used interchangeably. It will be understood that in some embodiments according to the invention, the term “continuous” (or “continuously”) can refer to the formation of at least some contiguous portions of the 3D object in situ. For example, in some embodiments according to the invention, different portions of the 3D object, which are contiguous with one another in the final 3D object, can both be formed sequentially within a gradient of polymerization. Furthermore, a first portion of the 3D object can remain in the gradient of polymerization while a second portion, that is contiguous with the first portion, is formed in the gradient of polymerization. Accordingly, the 3D object can be remotely fabricated, grown or produced continuously from the gradient of polymerization (rather than fabricated in discrete layers).

Additive Manufacturing Methods and Apparatus.

CLIP may be carried out as a bottom-up three dimensional additive manufacturing technique. In general, bottom-up additive manufacturing may be carried out by: (a) providing a carrier and an optically transparent member having a build surface, said carrier and said build surface defining a build region therebetween; (b) filling said build region with a polymerizable liquid, said polymerizable liquid comprising a mixture of (i) a light (typically ultraviolet light) polymerizable liquid first component, and (ii) a second solidifiable component of the dual cure system; (c) irradiating said build region with light through said optically transparent member to form a solid polymer scaffold from said first component and also advancing said carrier away from said build surface to form a three-dimensional intermediate having the same shape as, or a shape to be imparted to, said three-dimensional object and containing said second solidifiable component (e.g., a second reactive component) carried in said scaffold in unsolidified and/or uncured form; and (d) concurrently with or subsequent to said irradiating step, solidifying and/or curing (e.g., further reacting, further polymerizing, further chain extending), said second solidifiable component (e.g., by heating and/or microwave irradiating) in said three-dimensional intermediate to form said three-dimensional object.

As noted above, the products are preferably formed by continuous liquid interface production (CLIP). CLIP is known and described in, for example, PCT Applications Nos. PCT/US2014/015486 (also published as US 2015/0102532); PCT/US2014/015506 (also published as US 2015/0097315), PCT/US2014/015497 (also published as US 2015/0097316), and in J. Tumbleston, D. Shirvanyants, N. Ermoshkin et al., Continuous liquid interface production of 3D Objects, Science 347, 1349-1352 (published online 16 Mar. 2015). In some embodiments, CLIP employs features of a bottom-up three dimensional fabrication as described above, but the the irradiating and/or said advancing steps are carried out while also concurrently: (i) continuously maintaining a dead zone of polymerizable liquid in contact with said build surface, and (ii) continuously maintaining a gradient of polymerization zone (such as an active surface) between said dead zone and said solid polymer and in contact with each thereof, said gradient of polymerization zone comprising said first component in partially cured form. In some embodiments of CLIP, the optically transparent member comprises a semipermeable member (e.g., a fluoropolymer), and said continuously maintaining a dead zone is carried out by feeding an inhibitor of polymerization through said optically transparent member, thereby creating a gradient of inhibitor in said dead zone and optionally in at least a portion of said gradient of polymerization zone.

In some embodiments, CLIP may be carried out by optically establishing the dead zone and gradient of polymerization/active surface, such as by techniques explained in US Patent Application Publication No. US 2004/0181313 to Shih et al., in U.S. Pat. No. 8,697,346 to McLeod et al., S. Hell et al., Nanoscale Resolution with Focused Light: STED and Other RESOLFT Microscopy Concepts, in Handbook of Biological Confocal Microscopy (J. Pawley ed., 3d Ed. 2006); T. Andrew et al., Science, 324, 917-921 (2009); and T. Scott et al., Science 324, 913-917 (2009). In such case, the window or build plate may be either semipermeable, or may be impermeable to an inhibitor of polymerization (e.g., a single glass sheet). In some embodiments, CLIP may be carried out by generating the inhibitor of polymerization electrochemically, such as by an optically transparent electrode or electrode array associated with the window or build plate, by which oxygen is electrochemically generated from water included in the polymerizable liquid. Again, in such case, the window or build plate may be either semipermeable (e.g., a fluoropolymer) or may be impermeable to an inhibitor of polymerization (e.g., a single glass sheet).

While the dead zone and the gradient of polymerization zone do not have a strict boundary therebetween (in those locations where the two meet), the thickness of the gradient of polymerization zone is in some embodiments at least as great as the thickness of the dead zone. Thus, in some embodiments, the dead zone has a thickness of from 0.01, 0.1, 1, 2, or 10 microns up to 100, 200 or 400 microns, or more, and/or the gradient of polymerization zone and the dead zone together have a thickness of from 1 or 2 microns up to 400, 600, or 1000 microns, or more. Thus the gradient of polymerization zone may be thick or thin depending on the particular process conditions at that time. Where the gradient of polymerization zone is thin, it may also be described as an active surface on the bottom of the growing three-dimensional object, with which monomers can react and continue to form growing polymer chains therewith. In some embodiments, the gradient of polymerization zone, or active surface, is maintained (while polymerizing steps continue) for a time of at least 5, 10, 15, 20 or 30 seconds, up to 5, 10, 15 or 20 minutes or more, or until completion of the three-dimensional product.

The method may further comprise the step of disrupting the gradient of polymerization zone for a time sufficient to form a cleavage line in the three-dimensional object (e.g., at a predetermined desired location for intentional cleavage, or at a location in the object where prevention of cleavage or reduction of cleavage is non-critical), and then reinstating the gradient of polymerization zone (e.g. by pausing, and resuming, the advancing step, increasing, then decreasing, the intensity of irradiation, and combinations thereof).

CLIP may be carried out in different operating modes operating modes (that is, different manners of advancing the carrier and build surface away from one another), including continuous, intermittent, reciprocal, and combinations thereof.

Thus in some embodiments, the advancing step is carried out continuously, at a uniform or variable rate, with either constant or intermittent illumination or exposure of the build area to the light source.

In other embodiments, the advancing step is carried out sequentially in uniform increments (e.g., of from 0.1 or 1 microns, up to 10 or 100 microns, or more) for each step or increment. In some embodiments, the advancing step is carried out sequentially in variable increments (e.g., each increment ranging from 0.1 or 1 microns, up to 10 or 100 microns, or more) for each step or increment. The size of the increment, along with the rate of advancing, will depend in part upon factors such as temperature, pressure, structure of the article being produced (e.g., size, density, complexity, configuration, etc.).

In some embodiments, the rate of advance (whether carried out sequentially or continuously) is from about 0.1 1, or 10 microns per second, up to about to 100, 1,000, or 10,000 microns per second, again depending again depending on factors such as temperature, pressure, structure of the article being produced, intensity of radiation, etc.

In still other embodiments, the carrier is vertically reciprocated with respect to the build surface to enhance or speed the refilling of the build region with the polymerizable liquid. In some embodiments, the vertically reciprocating step, which comprises an upstroke and a downstroke, is carried out with the distance of travel of the upstroke being greater than the distance of travel of the downstroke, to thereby concurrently carry out the advancing step (that is, driving the carrier away from the build plate in the Z dimension) in part or in whole. While CLIP is the preferred additive manufacturing technique for carrying out the present invention, it will be appreciated that other bottom-up or top-down additive manufacturing techniques, including ink jet printer techniques, may also be used. Such methods are known and described in, for example, U.S. Pat. No. 5,236,637 to Hull, U.S. Pat. No. 7,438,846 to John, U.S. Pat. No. 8,110,135 to El-Siblani, and U.S. Patent Application Publication Nos. 2013/0292862 to Joyce and 2013/0295212 to Chen et al. The disclosures of these patents and applications are incorporated by reference herein in their entirety

Remote Additive Manufacturing Systems and Apparatus.

As used herein, the term “remote,” in the context of a remote 3D CLIP printer or printing, includes operations where a fabrication job can traverse a number of separately administered networks when dispatched by a user to a selected 3D CLIP printer. For example, each of the separately administered networks may be administered by different parties and/or a party other than that associated with the user. In some embodiments, the fabrication job can traverse a public network (such as the Internet). In some embodiments, the job can traverse more than two separate networks, including separate private networks. In some embodiments, the fabrication job can traverse both at least one public network and at least one private network.

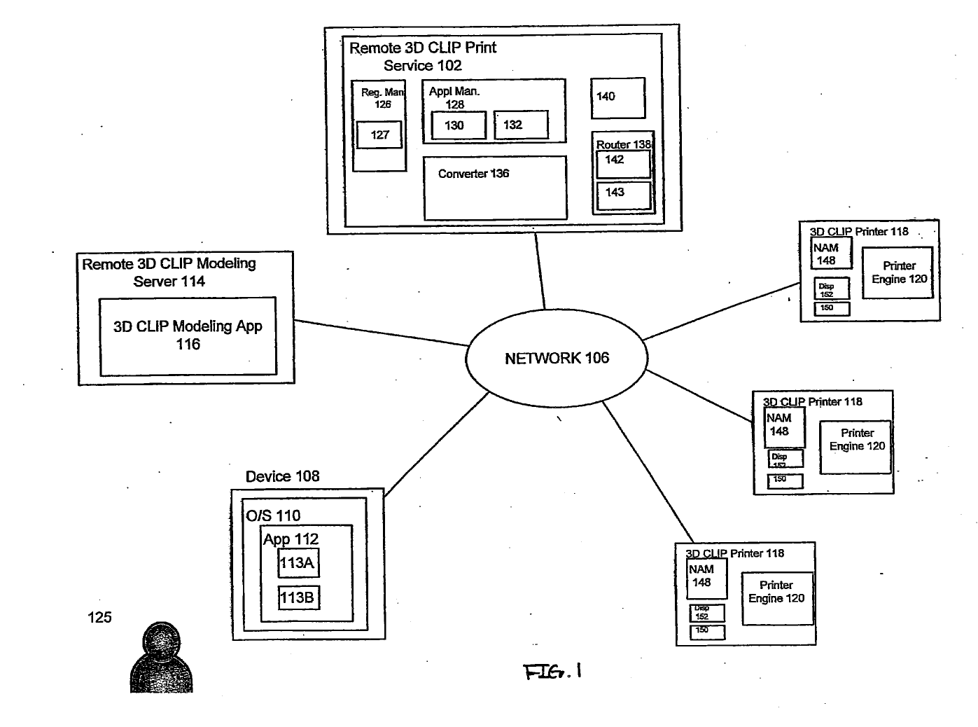

FIG. 1 is a block diagram of a system including a number of 3D CLIP printers 118 operatively coupled to a network 106, which may be selected for a fabrication job dispatched by a device 108. The device 108 can be any computing device from which a user can print to a selected 3D CLIP printer 118. By way of non-limiting example, the device 108 may include a laptop or desktop computer, a netbook, a tablet computer, a smartphone, a camera, or any device which may store or have access to a model corresponding to a 3D object, which the user may desire to fabricate. Although only three remote 3D CLIP printers 118 are illustrated in FIG. 1, the example embodiments can encompass any number of devices 118.

As further shown in FIG. 1, the system can also include a remote 3D CLIP print service 102 that may be executed on a remote 3D CLIP print server 104. The server 104 can provide for remote fabrication over the network 106 at the selected 3D CLIP printer 118. The remote 3D CLIP print service 102 may be platform-independent, which may unburden the user (or device 108) from the need to customize control of the 3D CLIP printers 118 or otherwise maintain or oversee 3D CLIP printer operations.

As shown in FIG. 1, an operating system 110 can be provided on the device 108 to support operation of an application 112. The application 112 can provide data representative of an object to be fabricated by the 3D CLIP printer 118 selected for fabrication. Any operating system may be used, such as the Windows operating system, Mac OS, or Linux, and may include mobile platforms such as Android, Symbian, or iPhone OS, or the like. In other examples, the operating system 110 may include a browser-based operating system, such as the Chrome OS. Consequently, the application 112 may include any application which may run on any underlying operating system or platform and is capable of producing data used for the fabrication of a 3D object.

The network 106 may be, for example, any combination of public and/or private networks, such as the Internet or other wide area public network, or a corporate or other intranet, or a smaller-scale, local or personal network, any of which may be implemented using standard network technology. The network 106 may also include a combination of different networks described herein.

In some embodiments, the remote 3D CLIP print service 102 is provided in what is sometimes referred to as a “cloud computing environment” which, generally speaking, includes a style of computing in which computing resources such as application programs and file storage are remotely provided over a network such as the Internet. Some of the characteristics of a cloud computing environment can include: on-demand self-service, wherein a consumer of resources may unilaterally provision computing capabilities, such as server time and network storage, as needed automatically without requiring human interaction with each service provider; broad network access, wherein capabilities can be available over the network and can be accessed through standard mechanisms that promote use by heterogeneous thin or thick client platforms (e.g., mobile phones, tablets, laptops, and workstations); resource pooling wherein computing resources can be pooled to serve multiple consumers using a multi-tenant model, with different physical and virtual resources dynamically assigned and reassigned according to consumer demand; rapid elasticity wherein capabilities may be elastically provisioned and released, in some cases automatically, to scale rapidly outward and inward commensurate with demand; measured service, wherein cloud systems may automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

For example, many web browsers are capable of running applications, which can themselves be application programming interfaces (“API's”) to more sophisticated applications running on remote servers. In the cloud computing paradigm, a web browser interfaces with and controls an application program that is running on a remote server. Through the browser, the user can manipulate data on the remote server via the remote application program. Similarly, using the remote 3D CLIP print service 102, the user can create (or dispatch) data representing the 3D object from the device 108 to the selected “cloud-aware” remote 3D CLIP printer 118.

In some embodiments, the remote 3D CLIP print service 102 enables the application 112 to print to the remote 3D CLIP printer 118, without a need for (e.g., independently of), involvement of the operating system 110 at the device level. In other words, the application 112 may communicate directly with the remote 3D CLIP print service 102 to thereby print to the remote 3D CLIP printer 118, without requiring a local driver within the operating system 110. As a result, any application 112 configured to communicate with the remote 3D CLIP print service 102 may make use of the remote 3D CLIP printer 118 via the remote 3D CLIP print service 102.

The system can provide an ability for any application running on any device 108 within the network 106 (e.g., the applications 112, 116 and device 108) to communicate with the remote 3D CLIP print service 102 to thereby print to any device which is also in (direct or indirect) communication with the remote 3D CLIP print service 102. Consequently, users may benefit from increased printing options and abilities, and experience an overall decrease in the costs and efforts associated with doing so by, for example, taking advantage of newer technology CLIP printers added to the remote 3D CLIP print service 102. Meanwhile, printer manufacturers may not need to provide users with the (updated) driver(s) and other prerequisites for users to fully experience the benefits of their products. This may result in, for example, higher customer satisfaction, and a decreased cost of fabricating 3D objects.

It will be understood that the remote 3D CLIP print service 102 can receive a fabrication job from the device 108 in a printer independent format, wherein the data may not be formatted for a particular 3D CLIP printer 118, but rather can be converted to whatever format is used by the printer selected for the fabrication job. Accordingly, the remote 3D CLIP print service 102 may provide a mechanism that converts the fabrication job from the printer independent format to a printer-specific format. For example, a converter 136 may convert the fabrication job from the printer independent format to the printer-specific format needed for the selected printer, and provide the converted fabrication job to the selected remote 3D CLIP printer 118 in order to carry out fabrication. In some embodiments, the converter 136 may be associated with the remote 3D CLIP print service 102 (e.g., shown in FIG. 1) or the converter 136 may be associated with a separate server.

The application 112 may provide a print dialog 113 in conjunction with the remote 3D CLIP print service 102. The print dialog 113 can include a printer list 113A identifying a number of the remote 3D CLIP printers 118. In some embodiments, the print dialog 113 may also identify selected remote 3D CLIP printers 118 that are associated with a user account. For example, the printer list 113A may include the entire list of printers associated with the user account. The entire list of printers may include a range of remote 3D CLIP printers 118 having different fabrication size capabilities, resins, speeds, instrumentation, feedback control capability, feed-forward control capability, associated geographic location, etc. In some embodiments, the entire list of printers can include those printers that are registered with the remote 3D CLIP print service 102 for a particular user as well as other publically-available printers that have registered with the remote 3D CLIP print service 102. The publically available printers may include printers that are made available under, for example, contract or on a per use basis, and may be located in the specified geographic areas.

Referring to FIG. 1, the remote 3D CLIP print server 104 may include a number of example components or modules which may be utilized to implement the functions of the remote 3D CLIP print service 102, and, in particular, may be utilized to implement the concepts and features related to remote 3D CLIP printing mechanisms. For example, the remote 3D CLIP print service 102 may include a registration manager 126, which may be configured to register remote 3D CLIP printers 118 and users. For example, the registration manager 126 may store identification information (e.g., serial number) for each registered printer including identification information for each sub-assembly in each printer. Sub-assemblies in the remote 3D CLIP printers 118 may be, for example, a build window and/or a carrier to which a top of an object under fabrication is attached. Accordingly, the registration manager 126 may be used to track the usage of each printer and sub-assembly to enable the remote 3D CLIP print service 102 to, for example, rotate the fabrication of identical (or similar) objects among a group of printers to avoid excessive wear to sub-regions of the build window.

The registration manager 126 may also be used to track whether sub-assemblies installed in remote 3D CLIP printers 118 are authorized by an entity having authority to control operation of the 3D CLIP printers 118 (e.g., licensor of the 3D CLIP printers 118) using identification information for the sub-assemblies. For example, the remote 3D CLIP print service 102 may disable a remote 3D CLIP printer 118 in which an unauthorized build window is installed or may notify the entity of usage of an unauthorized build window by comparing a serial number of the build window installed in the remote 3D CLIP printer 118 against serial numbers of authorized build windows. The registration manager 126 may store serial numbers of authorized build windows.

The registration manager 126 may be configured to receive a registration of the remote 3D CLIP printer 118, including storing identification information for the printer within a data store 127 of registered 3D CLIP printers. Also, the registration manager 126 may receive the public encryption keys from the 3D CLIP printers 118 when the printers register with the remote 3D CLIP print service 102. Further, the registration manager 126 may be configured to register a user(s) who may currently or potentially wish to execute fabrication jobs using the remote 3D CLIP print service 102, and to store identification information for such users within a data store of registered users.

The remote 3D CLIP print service 102 can also provide an application manager 128 configured to communicate with any application within the system of FIG. 1. Thus, the application, manager 128 may implement various application programming interfaces (APIs) which enable such communication with external applications. For example, the application manager 128 may include a print dialog API 130, which may be configured to render the print dialog 113 including the printer list 113A, and the printing options 113B. A job submit API 132 may be utilized to receive the identification of application content (information to fabricate the 3D object), the selected printer and printing options submitted by the user by way of the print dialog 113. The application manager 128 may receive the fabrication job in a format that is independent of a specific printer, e.g., generic with respect to all available or relevant printers within the system.

The fabrication jobs received at the application manager 128 may be passed to a job storage 140 which may provide one or more types of data storage related to operations of the remote 3D CLIP print service 102. For example, the job storage 140 may store fabrication jobs and related information, where such fabrication jobs/information may be stored prior to transmission to the selected 3D CLIP printer 118. For example, a fabrication job may be stored in a printer-independent format in which the fabrication job may have been received by the job submit API 132. Also, if the content is encrypted, the remote 3D CLIP print service 102 cannot obtain the details regarding the object to be fabricated.

According to some embodiments, a fabrication job router 138 may be configured to route the fabrication job (including encrypted content) from the application manager 128 or the job storage 140 to a selected printer, e.g., the remote 3D CLIP printer 118. The fabrication job router 138 may be configured to monitor and mediate execution and success/failure of a given fabrication. The fabrication job router 138 may thus be responsible for monitoring ongoing fabrication associated with a plurality of users, which may be designated for a corresponding plurality of 3D CLIP printers 118.

As shown, the fabrication job router 138 may include or otherwise be associated with a job fetch API 142 and/or a job control API 143. For example, the job fetch API 142 may be configured to provide the fabrication job to the remote 3D CLIP printer 118, e.g., may be used by the remote 3D CLIP printer 118 to fetch a desired fabrication job. The job control API 143 may be responsible for authorizing the remote 3D CLIP printer 118 as needed, and for receiving updated status information from the remote 3D CLIP printer 118, e.g., real-time video feedback of the fabrication in-progress, estimated time of completion, whether the fabrication failed, instrumentation status, etc. Such status information also may be stored using the job storage 140, in association with the corresponding fabrication job in question. The job control API 143 also may include status information including, e.g., whether a fabrication job is currently queued but not yet dispatched to a corresponding printer, or spooled/downloaded and added to a native printer queue of the remote 3D CLIP printer 118 (if applicable).

Still referring to FIG. 1, the system can also include a 3D CLIP modeling server 114 that provides access to a 3D CLIP modeling application 116 that is configured to generally model the physical performance of a range of 3D CLIP printers 118. The modeling application 116 can allow a user to examine a simulation of the fabricated object before actually fabricating the object. Such an approach may minimize the number of physical fabrication iterations needed to produce an acceptable object.

The modeling application 116 may also generate values for fabrication parameters associated with a range of 3D CLIP printers 118. It will be understood that the fabrication parameters can be, for example, inputs that can be provided to the 3D CLIP printers 118 to affect fabrication, such as a fabrication orientation, a thickness of a slice (e.g., a portion of a 3D object) that is fabricated using a set of the fabrication parameters, a fabrication speed, the build window wear compensation, a mode of irradiation, a temperature of a polymerizable liquid (e.g., resin) and the like. As an example, data for a given 3D object may be acted on by the modeling application 116 to generate the slice thickness and an associated fabrication speed for fabricating slices at that thickness. Other fabrication parameters may be used. Moreover, the values of the fabrication parameters may be dynamic as the fabrication progresses (i.e., changes as a function of the particular slice of the object being fabricated).

The modeling application 116 may generate the inputs for the printers to compensate for the physical processes presented at the printer during fabrication so that the 3D object is fabricated more accurately. For example, the modeling application 116 can use factors such as temperature variation during fabrication, deformation of the build window during fabrication, dynamic mechanical forces applied to the intermediate structures during fabrication, shrinkage of the object caused during fabrication, and the like.

Moreover, the modeling application 116 may also be constrained by specified fabrication inputs such as the particular resin to be used for fabrication, the speed at which the fabrication will be performed (e.g., total fabrication time, fabrication time per slice, etc.), a specified orientation for the fabrication of the object, etc. For example, when a particular resin and object orientation are specified as inputs, the modeling application 116 may specify a particular slice thickness and print speed as the fabrication parameter values, both of which may be compensated for by the model based on the physical processes associated with the particular 3D CLIP printer 118. Accordingly, the modeling application 116 can generate the values for the fabrication parameters of a particular 3D CLIP printer 118 based on the specified fabrication inputs and compensation for the physical processes exhibited at that printer 118.

In still other embodiments, the modeling application 116 may receive a specified outcome or objective or a type of polymerizable liquid as a fabrication input while other inputs remain unconstrained. For example, the specified outcome may be that the object be fabricated at the highest resolution possible, or in the shortest time, or having a minimum number of support structures on a specified surface, or to reduce wear on the build window, or to fabricate the object at the greatest dimensional accuracy. Given the outcome constraint, the modeling application 116 can generate the inputs to the printer 118 (using the compensation) that most nearly meet the objective.

In some embodiments, the modeling application 116 may receive objectives related to physical characteristics of a 3D object to be fabricated. For example, the physical characteristics of the 3D object may include stiffness and strength. A physical modeling (e.g., Finite Element Analysis (FEA)) may be used to generate values for the fabrication parameters of 3D CLIP printers 118 which meet the objectives related to physical characteristics. For example, the physical modeling may allow the modeling application 116 to automatically generate locations of support structures with consideration of deformation of the 3D object during fabrication. The physical modeling may require intensive computations, and the modeling application 116 may access multiple computing devices coupled to the network 106 to perform computations required by the physical modeling.

Finite Element Analysis (FEA) may be carried out in accordance with known techniques or variations thereof which will be apparent to those skilled in the art based on the present disclosure. See, e.g., Evan S. Gawlik, Hardik Kabaria and Adrian J. Lew, Int. J. Numer. Meth. Engng, doi: 10.1002/nme.4891 (2015); Hardik Kabaria, Adrian J. Lew and Bernardo Cockburn, Computer Methods in Applied Mechanics and Engineering 283, 303-329 (2015).

In some embodiments, the modeling application 116 may also use log data of past fabrication jobs performed by 3D CLIP printers 118 to generate the inputs to the printer 118. The log data of past fabrication jobs performed by 3D CLIP printers 118 may include, for example, an accumulated time that a build window has been used, a number of fabrication jobs that have been performed using a build window and/or sub-regions within a build window that have been used for fabrication. The values for fabrication parameters generated by the modeling application 116 may be stored in the 3D CLIP modeling server 114, the 3D CLIP print server 104 and/or the 3D CLIP printers 118.

In some embodiments, the modeling application 116 may provide a message identifying a possible failure mode and/or infeasible fabrication parameters when there arc no feasible values for some fabrication parameters, given the outcome constraint and the log data of past fabrication jobs, to guarantee results or printing performance. For example, if the modeling application 116 generates a fabrication speed that is higher than an allowed maximum fabrication speed of the 3D CLIP printers 118 or that is higher than a maximum fabrication speed that the 3D CLIP printers 118 can be operated without causing a build window failure, the modeling application 116 may provide a message rather than values for fabrication parameters. It will be understood that ranges of fabrication parameters are stored in the 3D CLIP modeling server 114 and/or the CLIP Print Server 104.

It will be further understood that the general approach described above can be used to model the behavior of a range of 3D CLIP printers 118. In particular, the modeling application 116 may generate respective values for the fabrication parameters of each of the remote 3D CLIP printers 118 available over the network. Moreover, the values can be based on the specified fabrication inputs and on compensation for each of the printers 118. For example, each of the remote 3D CLIP printers 118 on the network may have respective physical processes that are exhibited during fabrication. Accordingly, the fabrication parameter values can be different for each of the remote 3D CLIP printers 118, based on the different compensation that may be used for each. When the user selects a particular printer 118 for fabrication, the modeling application 116 may therefore provide the fabrication parameter values generated for the selected printer 118 for the particular object to be fabricated.

Still further, the modeling application 116 can also provide a specified control mechanism to the remote 3D CLIP printer 118 that is selected for fabrication. For example, in some embodiments according to the invention, the modeling application 116 may determine, based on the selected remote 3D CLIP printer 118, that a feed-forward control mechanism should be used during fabrication. The selection of the feed-forward control mechanism can be based on, for example, the type of resin used in the printer 118, the speed in which the fabrication is to proceed, the degree to which sensors are incorporated into the printer 118, etc. For example, the modeling application 116 may determine that the selected remote 3D CLIP printer 118 has limited instrumentation, and therefore a feed-forward control mechanism should be used during fabrication, whereas if the modeling application 116 determines that the printer 118 includes a more robust set of sensors, a feed-back control mechanism may be used.

Still further, in some embodiments according to the invention, the modeling application 116 may determine that a combination of feed-forward and feed-back control mechanisms should be used by the 3D printer 118 during fabrication. For example, the selected 3D CLIP printer 118 may access log files associated with previous fabrications to determine whether a feed-back or feed-forward control mechanism should be used given the similarities or dissimilarities between those previous fabrications and the current fabrication for the selected printer 118. In still other embodiments according to the invention, the modeling application 116 may specify that a feed-forward control mechanism should be used during one portion of the fabrication whereas a feed-back control mechanism should be used during another portion of the fabrication. Feed-forward control mechanisms are described further in reference to Example 1 hereinbelow.

It will be further understood that the fabrication parameter values generated by the modeling application 116 described herein can be provided directly or indirectly to the selected 3D CLIP printer 118. For example, in some embodiments, the modeled fabrication parameter values can be provided by the modeling application 116 directly to the 3D CLIP printer selected for fabrication. In other embodiments the modeled fabrication parameter values can be provided by the modeling application 116 to the remote 3D CLIP print service 102, which manages the 3D CLIP printer selected for fabrication.

In some embodiments, the application 116 may be hosted on the device 108, rather than configured as a service available to multiple devices as described above. Accordingly, the application 116 may be used to model fabrication parameter values for a relatively narrow range of objects and/or 3D CLIP printers 118. In some embodiments, the application 116 may be hosted on the 3D CLIP printer 118, and therefore may be limited to modeling fabrication parameter values for that particular 3D CLIP printer 118.

In still further embodiments, the application 116 may provide the functionality described herein as a “web application” allowing an owner of the server 114 to assume responsibility for installing, configuring, executing, and maintaining the application 116 at the server 114, so that the devices 108 may obtain the benefit of the application 116 without many or any of the associated costs and responsibilities. Thus, the 3D CLIP modeling server 114 and the 3D CLIP modeling application 116 can also represent examples of cloud computing.

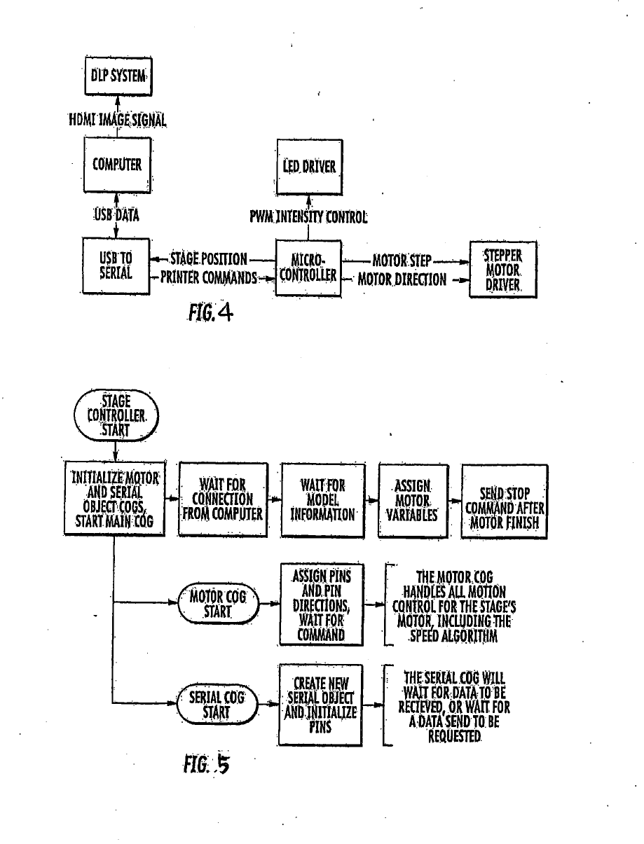

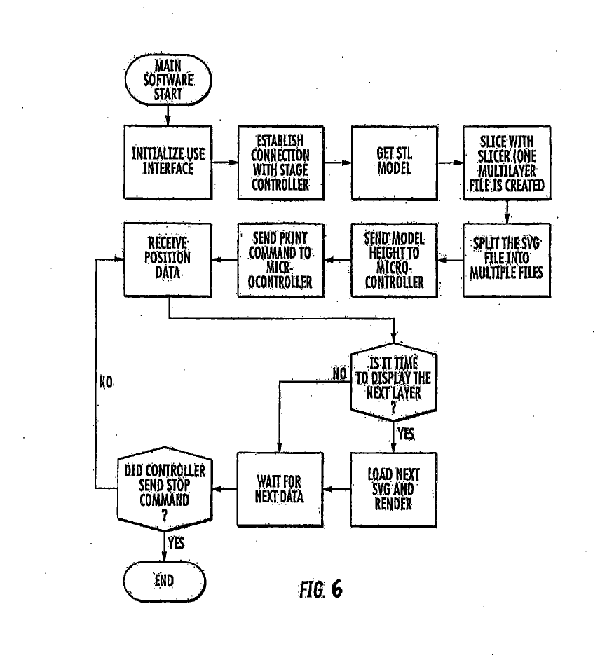

The 3D CLIP printer 118 includes a printer engine 120 configured to carry out received fabrication jobs in accordance with the inputs provided by, for example, the remote 3D CLIP print service 102. For example, the printer engine 120 can operate as shown in FIGS. 4-6, and described in the text associated with those Figures.

The 3D CLIP printer 118 can include a number of sensors and/or circuits configured to monitor operation of the 3D CLIP printer 118 during fabrication. In some embodiments according to the invention, sensors can be utilized to monitor the brightness of the irradiation circuit (such as an LED or laser), the current in the irradiation circuit (such as the current in an LED or LED array), and the irradiation circuit temperature. Accordingly, the sensors may monitor the performance of the irradiation circuit to correct output given changes in current and temperature associated with the irradiation circuit.

The 3D CLIP printer 118 can also include a sensor(s) to determine the level of the resin to ensure that the level does not drop below a minimum needed for continuous fabrication in the gradient of polymerization. The 3D CLIP printer 118 can also include various identifications of subsystems included therein such as the cassette, the light engine serial number, etc. The serial numbers can be used to identify particular 3D CLIP printers 118 and the log data associated with the performance thereof over time, particularly when the 3D CLIP printer 118 is relocated within the system shown in FIG. 1 but is to be managed consistently over time as the printer 118 is relocated within the system. In still further embodiments according to the invention, the 3D CLIP printer 118 can include sensors that indicate the status of various spaces within the printer and positions of mechanisms, such as the position of doors, the position of the build platform, whether the build platform is currently occupied, and the position of the motor used to drive the carrier, etc.

In still further embodiments according to the invention, the 3D CLIP printer 118 can include various temperature sensors to indicate the associated temperature of the cassette, the temperature of the resin that is delivered into the build platform, and the temperature of the build platform itself. In still further embodiments according to the invention, the 3D CLIP printer 118 can include sensors to indicate vibration of the build platform, whether the resin cartridge is properly installed, and whether resin has spilled. Other sensors may also be incorporated into the 3D CLIP printer 118.

The 3D CLIP printer 118 can also include a network access manager 148 to enable communications with the remote 3D CLIP print service 102 over the network 106. The network access manager 148 may be provided via associated hardware/software, such as that illustrated in FIG. 1. For example, such communication may be conducted wirelessly if the remote 3D CLIP printer 118 is within range of an appropriate wireless network. In other examples, the network access manager 148 may enable a wired connection of the remote 3D CLIP printer 118 to the network 106, e.g., by way of connection to an appropriate router.

The user interface 150 may represent virtually any sort of keypad, stylus, or other input technique for entering data to the remote 3D CLIP printer 118 including the user-defined password. Similarly, the display 152 may represent virtually any sort of audio and/or video display to output information to the user 125 or other user of the remote 3D CLIP printer 118.

It will be appreciated that many other configurations of the remote 3D CLIP printer 118 or other printers are contemplated for use in conjunction with the system. For example, some of the remote 3D CLIP printers 118 may not include the network access manager 148 and/or firmware which may be utilized to operate the printer engine 120, and communicate with the remote 3D CLIP print service 102. In such cases, a print client may be configured to execute on or in conjunction with a computing device which is in communication with the printer, and which has the available resources necessary to implement the functionalities described herein. Other variations and implementations of the printer 118 or related printers would be apparent, and are not described here in detail, except as may be necessary or helpful in understanding operations of the roving printer scenarios described herein.

It will be understood that the system shown in FIG. 1 can be employed to provide a general environment or marketplace for remote 3D CLIP printers 118. For example, in some embodiments according to the invention, the users of the system shown in FIG. 1 may register with the remote 3D CLIP print service 102 to access a wide range of 3D CLIP printers 118 each of which may have specific capabilities which may be particularly suited for a particular fabrication job desired by the user. Accordingly, third parties may provide 3D CLIP printers 118 as part of the system so that the users can fabricate objects on a contract basis. Moreover, the 3D CLIP printers 118 may be distributed in different geographic locations such that the users may select a particular 3D CLIP printer 118 for a fabrication job based on where the 3D object is to be ultimately delivered and/or used. For example, if an end user for a particular 3D object to be fabricated is located in a remote geographical region relative to the user of the device 108, a remote 3D CLIP printer 118 located relatively close to the remote geographical region may be selected for fabrication of the object.

It will be understood that the portions of the description that follow describe various embodiments of the 3D CLIP printer 118 as well as examples of fabrication processes carried out using exemplary 3D CLIP printers 118. Accordingly, it will be understood that any of the following embodiments may be utilized as a component in the system shown in FIG. 1.

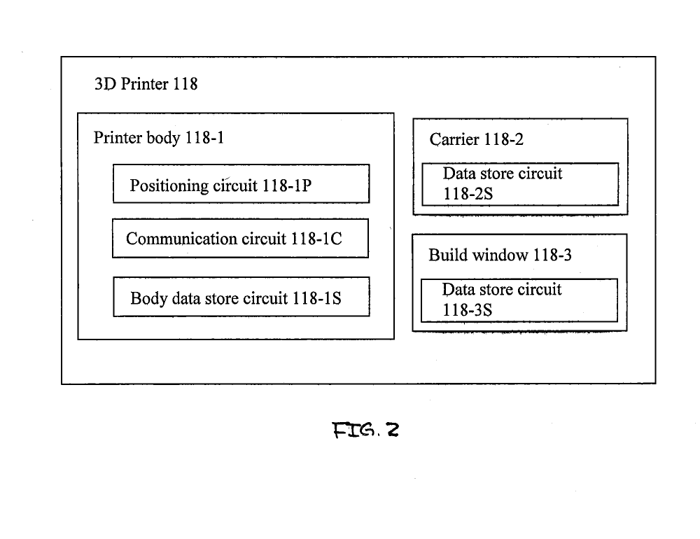

FIG. 2 is a block diagram of a 3D printer, such as a 3D CLIP printer 118, in some embodiments according to the invention. The 3D CLIP printer 118 may include a printer body 118-1, a carrier 118-2 and a build window 118-3. As appreciated by the inventors, the carrier 118-2 and the build window 118-3 need to be spaced apart from each other by a predetermined distance (e.g., 100 micrometer) when fabrication of a 3D object starts. The predetermined distance between the carrier 118-2 and the build window 118-3 may need to provide acceptable printing performance and/or not to cause physical damage to the build window 118-3 by the carrier 118-2. For example, the build window 118-3 may be cracked or torn if the carrier 118-2 hits the build window 118-3. In some embodiments of the invention, a distance between the carrier 118-2 and the build window 118-3 may be controlled to be uniform in the entire area between the carrier 118-2 and the build window 118-3, and a deviation from the predetermined distance in the entire area may be controlled within a narrow range (e.g., ±2 micrometer).

The carrier 118-2 and the build window 118-3 may be positioned at starting heights corresponding to the predetermined distance when fabrication of a 3D object starts. The starting heights of the carrier 118-2 and the build window 118-3 may vary according to dimensions (e.g., height) of the printer body 118-1 and types and/or dimensions of the carrier 118-2 and the build window 118-3 for the given predetermined distance. Accordingly, the starting heights of the carrier 118-2 and the build window 118-3 may be determined when one of the carrier 118-2 and the build window 118-3 is replaced based on dimensions of the printer body 118-1 and types and/or dimensions of the carrier 118-2.

Each of the carrier 118-2 and the build window 118-3 may include a data store circuit, 118-2S and 118-3S, that stores identification information for the carrier 118-2 and the build window 118-3. For example, the data store circuits 118-2S and 118-3S may store serial numbers of the carrier 118-2 and the build window 118-3.

The printer body 118-1 may include a communication circuit 118-1C that performs communication with the data store circuits 118-2S and 118-3S of the carrier 118-2 and the build window 118-3 to receive the identification information for the carrier 118-2 and the build window 118-3 stored in the data store circuits 118-2S and 118-3S of the carrier 118-2 and the build window 118-3. In some embodiments, the communication circuit 118-1C may perform near field communication (NFC) with the data store circuits 118-2S and 118-3S. The communication circuit 118-1C may initiate communication by generating a carrier field (e.g., RF field), and the data store circuits 118-2S and 118-3S may be activated responsive to the carrier field and may transmit the identification information for the carrier 118-2 and the build window 118-3 to the communication circuit 118-1C. The data store circuits 118-2S and 118-3S each may be a near field communication (NFC) tag (e.g., RFID).

The communication circuit 118-1C may also supply power to the data store circuits 118-2S and 118-3S using the carrier field such that the data store circuits 118-2S and 118-3S may not have any power source. The data store circuits 118-2S and 118-3S may encrypt the identification information for the carrier 118-2 and the build window 118-3 before transmitting those to the communication circuit 118-1C.

In some embodiments, the 3D CLIP printer 118 may include a body data store circuit 118-1S that provides the starting heights of the carrier 118-2 and the build window 118-3 based on the identification information for the 3D CLIP printer 118, the carrier 118-2 and the build window 118-3. For example, the body data store circuit 118-1S may include a database that outputs the starting heights of the carrier 118-2 and the build window 118-3 responsive to input data including the identification information for the 3D CLIP printer 118, the carrier 118-2 and the build window 118-3.

In some embodiments, the starting heights of the carrier 118-2 and the build window 118-3 may be provided by the remote 3D CLIP print server 104 as discussed above with reference to FIG. 1. The remote 3D CLIP print server 104 may include a database that outputs the starting heights of the carrier 118-2 and the build window 118-3 responsive to input data including the identification information for the 3D CLIP printer 118, the carrier 118-2 and the build window 118-3.

The printer body 118-1 may also include a positioning circuit 118-1P that positions the carrier 118-2 and the build window 118-3 at the starting heights provided by the body data store circuit 118-1S and/or the remote 3D CLIP print server 104. In some embodiments, the positioning circuit 118-1P may detect whether the carrier 118-2 and the build window 118-3 are tilted and may set the carrier 118-2 and the build window 118-3 at level.

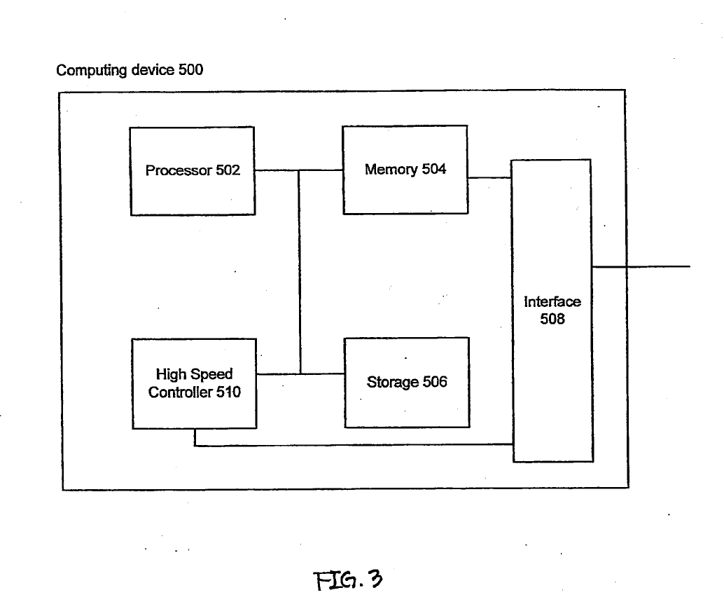

FIG. 3 is a block diagram showing example or representative computing devices and associated elements that may be used to implement the supporting infrastructure shown in FIG. 1, such as the servers 104 and 114, device 108, and the printer engine 120 as well as other components located within (or otherwise associated with) the remote 3D CLIP printers 118 used to facilitate the operations described herein over the network 106.

FIG. 3 shows an example of a generic computing device 500, which may be used with the techniques described herein. Computing device 500 is intended to represent various forms of digital computers, such as laptops, desktops, workstations, personal digital assistants, servers, blade servers, mainframes, controllers, and other appropriate computers. The components shown herein, their connections and relationships, and their functions, are meant to be exemplary only, and are not meant to limit implementations of the inventions described and/or claimed.

Computing device 500 includes a processor 502, memory 504, a storage device 506, a high-speed interface 508 connected to memory 504. Each of the components, is interconnected using various buses, and may be mounted on a common motherboard or in other manners as appropriate. The processor 502 can process instructions for execution within the computing device 500, including instructions stored in the memory 504 or on the storage device 506 to display graphical information for a GUI on an external input/output device. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502. The high speed controller 510, used for example to operate the printer engine 120, manages bandwidth-intensive operations for the computing device 500. Such allocation of functions is exemplary only.

The computing device 500 may be implemented in a number of different forms. For example, it may be implemented as a standard server, or multiple times in a group of such servers. It may also be implemented as part of a rack server system. In addition, it may be implemented in a personal computer such as a laptop computer. Alternatively, components of computing device 500 may be combined with other components.

### Example 1

### Resin Feed Rate Control: Feed-Forward Control

During the part build process the resin consumption rate changes based on the cross sectional area of the part. A process to control resin delivery rate is described below. If the build speed is v and the cross section of the part A varies with time t as A(t) then resin delivery rate can be adjusted to correspond, in whole or in part, to:

R(t)=vA(t)

For example, during the build process a central processing unit (CPU) serving as a controller can in real time calculate the current cross section of the part, then calculate delivery rate based on a rule such as the equation above and communicate the calculated rate to a resin delivery pump controller (RDPC). The RDPC can then adjust the speed of the resin delivery pump based on the data received from CPU.

Such a feed-forward control system can be used alone or in combination with other feed-forward and feed-back control systems (e.g., temperature and/or pressure control).

### Example 2

### Control of Method and Apparatus

The remote 3D CLIP printers may be controlled by a software program running in a general purpose computer with suitable interface hardware between that computer and the apparatus described above. Numerous alternatives are commercially available. Non-limiting examples of one combination of components is shown in FIGS. 4-6, where “Microcontroller” is Parallax Propeller, the Stepper Motor Driver is Sparkfun EasyDriver, the LED Driver is a Luxeon Single LED Driver, the USB to Serial is a Parallax USB to Serial converter, and the DLP System is a Texas Instruments LightCrafter system.

It will be understood that various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, steps, operations, elements components and/or groups or combinations thereof, but do not preclude the presence or addition of one or more other features, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention.

What is claimed:

1. A remote three-dimensional (3D) Continuous Liquid Interface Production (CLIP) system comprising:
a plurality of 3D CLIP printers configured to fabricate 3D objects responsive to remote data corresponding the 3D objects, the plurality of 3D CLIP printers being operatively coupled to a network by which the remote data is received by the plurality of 3D CLIP printers.

2. The system of claim 1 further comprising:
a remote 3D CLIP print server operatively coupled to the network, the remote 3D CLIP print server being configured to provide a remote 3D CLIP print service by which fabrication jobs corresponding to the 3D objects are provided to the plurality of 3D CLIP printers.

3. The system of claim 2 further comprising:
an electronic device operatively coupled to the network, the electronic device being configured to operatively couple to the remote 3D CLIP print service via the network to dispatch a respective fabrication job to a selected one of the plurality of 3D CLIP printers.

4. The system of claim 3, wherein the remote 3D CLIP print service is configured to identify the selected one of the plurality of 3D CLIP printers.

5. The system of claim 4, wherein the remote 3D CLIP print service is configured to identify the selected one of the plurality of 3D CLIP printers responsive to a remote input at the electronic device.

6. The system of claim 1 further comprising:
a 3D CLIP modeling server operatively coupled to the network, the 3D CLIP modeling server being configured to provide a remote 3D CLIP modeling service by which the remote data is processed to provide an input to the plurality of 3D CLIP printers.

7. The system of claim 6, wherein the input provided by the remote 3D CLIP modeling service comprises values for fabrication parameters utilized by the plurality of 3D CLIP printers for fabrication of the corresponding the 3D objects.

8. The system of claim 6, wherein the 3D CLIP modeling server is configured to receive a remote input via the network,
wherein the remote 3D CLIP modeling service processes the remote data, the remote input and log data of past fabrication jobs performed by the plurality of 3D CLIP printers to provide the input to the plurality of 3D CLIP printers for fabrication, and
wherein the input provided by the remote 3D CLIP modeling service comprises values for fabrication parameters utilized by the plurality of 3D CLIP printers for fabrication of the corresponding the 3D objects or a message identifying a possible failure mode or infeasible fabrication parameters.

9. The system of claim 8, wherein the fabrication parameters comprise a fabrication orientation, a thickness of a portion of the 3D objects that is fabricated using a set of the fabrication parameters, a fabrication speed, a mode of irradiation and/or a temperature of a polymerizable liquid used to fabricate the 3D objects.

10. The system of claim 8, wherein the remote input data comprises a type of a polymerizable liquid, a resolution and/or a fabrication speed.

11. The system of claim 8, wherein the log data of past fabrication jobs comprises an accumulated time that a build window in ones of the plurality of 3D CLIP printers has been used, a number of fabrication jobs that have been performed using a build window in ones of the plurality of 3D CLIP printers and/or sub-regions of a build window in ones of the plurality of 3D CLIP printers that have been used.

12. The system of claim 2, wherein the remote 3D CLIP print service is configured to dispatch a respective fabrication job to a selected one of the plurality of 3D CLIP printers based on log data of past fabrication jobs performed by the plurality of 3D CLIP printers.

13. A three-dimensional (3D) Continuous Liquid Interface Production (CLIP) printer configured to sequentially fabricate, in situ, contiguous portions of a 3D object in a gradient of polymerization comprising:
a network access manager configured to operatively couple to a network to provide the 3D CLIP printer via the network.

14. The 3D CLIP printer of claim 13, wherein the network access manager is further configured to operatively couple to a remote 3D CLIP print service by which a fabrication job corresponding to the 3D object is provided to the 3D CLIP printer.

15. The 3D CLIP printer of claim 13, wherein the network access manager is further configured to operatively couple to a 3D CLIP modeling server configured to provide a remote 3D CLIP modeling service by which remote data corresponding the 3D object is processed to provide an input to the 3D CLIP printer.

16. The 3D CLIP printer of claim 15, wherein the input provided by the remote 3D CLIP modeling service comprises values for fabrication parameters utilized by the 3D CLIP printer for fabrication of the corresponding the 3D object.

17. A remote three-dimensional (3D) Continuous Liquid Interface Production (CLIP) system comprising:
a registration manager operatively coupled to a network, wherein the registration manager is configured to store identification information for each registered remote 3D CLIP printers and identification information for at least one sub-assembly in each registered remote 3D CLIP printers, and
wherein the registration manager is further configured to track whether the at least one sub-assembly in the each registered remote 3D CLIP printer is authorized by an entity having authority to control operation of the registered remote 3D CLIP printers using the identification information for the each sub-assembly.

18. The system of claim 17, wherein the registration manager is further configured to disable ones of the remote 3D CLIP printers in which an unauthorized sub-assembly is installed.

19. The system of claim 18, wherein the sub-assembly comprises a build window, and the identification information for the sub-assembly comprises a serial number.

20. The system of claim 17, wherein the registration manager is further configured to notify the entity of usage of an unauthorized sub-assembly in ones of the registered remote 3D CLIP printers.

21. A remote three-dimensional (3D) Continuous Liquid Interface Production (CLIP) system comprising:
a 3D CLIP printer configured to fabricate a 3D object responsive to remote data corresponding the 3D object, wherein the 3D CLIP printer is operatively coupled to a network by which the remote data is received by the 3D CLIP printer,
wherein the 3D CLIP printer comprises a build window, a carrier and a printer body, and
the printer body comprises a positioning circuit configured to position the build window and the carrier at starting heights that are determined based on identification information for the 3D CLIP printer, the build window and the carrier.

22. The system of claim 21, wherein each of the build window and the carrier comprises a data store circuit configured to store the identification information for the build window and the carrier, and
wherein the printer body of the 3D CLIP printer comprises a communication circuit configured to receive the identification information for the build window and the carrier from the data store circuits of the build window and the carrier.

23. The system of claim 22, wherein the communication circuit is configured to receive the identification information for the build window and the carrier by performing near-field communication (NFC) with the data store circuits of the build window and the carrier.

24. The system of claim 22, wherein the printer body of the 3D CLIP printer comprises a body data store circuit configured to provide the starting heights of the build window and the carrier to the positioning circuit responsive to the identification information for the build window and the carrier received from the communication circuit and the identification information for the 3D CLIP printer.

25. The system of claim 22, further comprising a remote 3D CLIP print server operatively coupled to the network and configured to provide the starting heights of the build window and the carrier responsive to the identification information for the 3D CLIP printer, the build window and the carrier.
